(19) United States
(12) Patent Application Publication
(10) Pub. No.: US 2023/0117768 A1
(43) Pub. Date: Apr. 20, 2023

(54) METHODS AND SYSTEMS FOR UPDATING OPTIMIZATION PARAMETERS OF A PARAMETERIZED OPTIMIZATION ALGORITHM IN FEDERATED LEARNING

(71) Applicants: Kiarash SHALOUDEGI, Cote Saint-Luc (CA); Yaoliang YU, Waterloo (CA); Jun LUO, Toronto (CA)

(72) Inventors: Kiarash SHALOUDEGI, Cote Saint-Luc (CA); Yaoliang YU, Waterloo (CA); Jun LUO, Toronto (CA)

(21) Appl. No.: 17/965,274

(22) Filed: Oct. 13, 2022

Related U.S. Application Data
(60) Provisional application No. 63/256,302, filed on Oct. 15, 2021.

(51) Int. Cl. G06N 20/00; G06K 9/62

(52) U.S. Cl. CPC G06N 20/00; G06K 9/6262; G06K 2009/6237

(57) ABSTRACT

Methods and systems for federated learning using a parameterized optimization algorithm are described. A central server receives, from each of a plurality of user devices, a proximal map and feedback representing a current state of each user device. The server computes an update to optimization parameters of a parameterized optimization algorithm, using the received feedback. Model updates are computed for each user device, using the received proximal maps and the parameterized optimization algorithm having the updated optimization parameters. Each model update is transmitted to each respective client for updating the respective model.

### CROSS-REFERENCE TO RELATED APPLICATIONS

The present disclosure claims priority from U.S. provisional patent application No. 63/256,302, entitled “METHODS AND SYSTEMS FOR UPDATING PARAMETERS OF A PARAMETERIZED OPTIMIZATION ALGORITHM IN FEDERATED LEARNING”, filed Oct. 15, 2021, the entirety of which is hereby incorporated by reference.

### FIELD

The present disclosure relates to methods and systems for training and deployment of machine learning-based models using federated learning, in particular methods and systems for training a machine learning-based model using federated learning in which the optimization algorithm in federated learning is parameterized.

### BACKGROUND

The usefulness of artificial intelligence (AI) or machine-learning systems rely on the large amounts of data that are used in the training of a machine learning-based model related to a task. There has been interest in how to leverage data from multiple diversified sources, to learn a model related to a task using machine learning.

Federated learning is a machine learning technique, in which multiple local data owners (also referred to as users, clients or nodes) participate in training a model (i.e., learning the parameters of a model) related to a task in a collaborative manner without sharing their local data with each other. Thus, federated learning has been of interest as a solution that allows for training a model related to a task using large amounts of local data (otherwise known as user-generated data), such as photos, biometric data, etc., without violating data privacy. An existing approach for federated learning is referred to as federated averaging (FedAvg). In FedAvg, a model related to a task is trained to optimize the parameters of the model related to the task over several rounds of training. In each round of training, a central server communicates the current model (e.g., the current parameters for the model) related to the task to selected users and each user updates its own model (e.g., updates its own parameters for the model) related to the task based on the current model received from the central server. In particular, each user uses its own local data to train its own local model related to the task to update the local model (i.e. learn the parameters of the local model). The updated models are then sent back to the central server by the users, and the central server uses all the updated models to update the model related to the task. After several rounds of training, the model related to the task converges to an optimized model (i.e., the model parameters converge to some set of optimal values).

The amount of data that is communicated in each round of training and the number of rounds of training required for the model related to the task to converge (e.g., the parameters of the model related to the task are no longer significantly updated with each round of training) contribute to communication cost (e.g., use of network resources such as bandwidth) that may impact the practical application of federated learning. One way to reduce this communication cost is to design an optimization algorithm that is used during training of the model related to the task that results in faster convergence of the model related to the task. Existing approaches to federated learning typically rely on a manually designed or manually selected optimization algorithm.

It would be useful to provide a solution that does not rely on manual design or manual selection of an optimization algorithm used during federated learning.

### SUMMARY

In various examples, the present disclosure describes methods and systems for federated learning, in which an optimization algorithm used to update the parameters of a model related to a task is itself parameterized and the optimization parameters of the parameterized optimization algorithm may be updated during each round of training. The optimization parameters of the optimization algorithm may be updated using various algorithms, without requiring manual design or selection of a particular optimization algorithm to use.

The present disclosure may provide the technical advantage that a model related to a task can be trained using federated learning with fewer rounds of training, hence reducing communication costs. This may help to improve the practical applicability of federated learning.

The present disclosure describes example embodiments in the context of federated learning, however it should be understood that disclosed example embodiments may also be adapted for implementation in the context of any distributed optimization or distributed learning systems used to train a model related to a task.

In some example aspects, the present disclosure describes a method performed by a server, the method including: receiving, from each of a plurality of user devices, a respective proximal map; receiving, from each of the plurality of user devices, respective feedback representing a current state of each respective user device; computing an update to optimization parameters of a parameterized optimization algorithm, using the received feedback; computing model updates, each model update corresponding to a respective model at a respective user device, using the received proximal maps and the parameterized optimization algorithm having the updated optimization parameters; and transmitting each model update to each respective client for updating the respective model.

In an example of the preceding example aspect of the method, the update to the optimization parameters may be computed for one round of training in a defined training period, and the optimization parameters may be fixed for other rounds of training in the defined training period.

In an example of any of the preceding example aspects of the method, the update to the optimization parameters may be computed using a K-armed bandit algorithm.

In an example of a preceding example aspect of the method, computing the update to the optimization parameters may include computing the update to the optimization parameters using a reinforcement learning agent, where the reinforcement learning agent may learn a policy to map the received feedback to the updated optimization parameters.

In an example of the preceding example aspect of the method, the feedback received from each user device may include a loss function computed using the current state of the respective model at each user device, where the reinforcement learning agent may learn the policy using a cumulative reward computed from the loss functions received from the user devices.

In an example of a preceding example aspect of the method, the update to the optimization parameters may be computed using a pre-trained policy, where the policy may be pre-trained using a supervised learning algorithm to map loss functions received as feedback from the user devices to the updated optimization parameters.

In an example of any of the preceding example aspects of the method, computing the model updates may include: computing a set of weighted proximal map auxiliary variables using the received proximal maps, a set of prior model updates, and a first one of the updated optimization parameters; computing a set of second auxiliary variables using the set of weighted proximal map auxiliary variables, a projection of the set of weighted proximal map auxiliary variables onto a consensus set, and a second one of the updated optimization parameters; and computing the model updates using the set of prior model updates, the set of second auxiliary variables, and a third one of the update optimization parameters.

In an example of any of the preceding example aspects of the method, the feedback representing a current state of each respective user device may represent at least one of: a current state of user data local to the respective user device, a current state of an observed environment, or a current state of the model of the respective user device.

In some example aspects, the present disclosure describes a method performed by a server, the method including: receiving, from each of a plurality of user devices, a respective weighted proximal map; receiving, from each of the plurality of user devices, respective feedback representing a current state of each respective user device; computing an update to optimization parameters of a parameterized optimization algorithm, using the received feedback; computing, using the weighted proximal maps, a consensus projection; and transmitting the updated optimization parameters and computed consensus projection to each of the plurality of user devices, to enable updating a respective model at each respective user device.

In an example of the preceding example aspect of the method, the update to the optimization parameters may be computed using a K-armed bandit algorithm.

In an example of a preceding example aspect of the method, computing the update to the optimization parameters may include computing the update to the optimization parameters using a reinforcement learning agent, where the reinforcement learning agent may learn a policy to map the received feedback to the updated optimization parameters.

In an example of the preceding example aspect of the method, the feedback received from each user device may include a loss function computed using the current state of the respective model at each user device, where the reinforcement learning agent may learn the policy using a cumulative reward computed from the loss functions received from the user devices.

In an example of a preceding example aspect of the method, the update to the optimization parameters may be computed using a pre-trained policy, where the policy may be pre-trained using a supervised learning algorithm to map loss functions received as feedback from the user devices to the updated optimization parameters.

In some example aspects, the present disclosure describes a computing system including a memory; and a processing unit in communication with the memory, the processing unit configured to execute instructions to cause the computing system to: receive, from each of a plurality of user devices, a respective proximal map; receive, from each of the plurality of user devices, respective feedback representing a current state of each respective user device; compute an update to optimization parameters of a parameterized optimization algorithm, using the received feedback; compute model updates, each model update corresponding to a respective model at a respective user device, using the received proximal maps and the parameterized optimization algorithm having the updated optimization parameters; and transmit each model update to each respective client for updating the respective model.

In an example of the preceding example aspect of the system, the update to the optimization parameters may be computed for one round of training in a defined training period, and the optimization parameters may be fixed for other rounds of training in the defined training period.

In an example of any of the preceding example aspects of the system, the update to the optimization parameters may be computed using a K-armed bandit algorithm.

In an example of a preceding example aspect of the system, the processing unit may be further configured to execute instructions to cause the computing system to compute the update to the optimization parameters by computing the update to the optimization parameters using a reinforcement learning agent, where the reinforcement learning agent may a policy to map the received feedback to the updated optimization parameters.

In an example of the preceding example aspect of the system, the feedback received from each user device may include a loss function computed using the current state of the respective model at each user device, where the reinforcement learning agent may learn the policy using a cumulative reward computed from the loss functions received from the user devices.

In an example of a preceding example aspect of the system, the update to the optimization parameters may be computed using a pre-trained policy, where the policy may be pre-trained using a supervised learning algorithm to map loss functions received as feedback from the user devices to the updated optimization parameters.

In an example of any of the preceding example aspects of the system, the feedback representing a current state of each respective user device may at least one of: a current state of user data local to the respective user device, a current state of an observed environment, or a current state of the model of the respective user device.

In some example aspects, the present disclosure describes a non-transitory computer readable medium storing instructions, wherein the instructions, when executed by a processing unit of a computing system, cause the computing system to perform any of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram of a simplified example system that may be used to implement federated learning;

FIG. 2 is a block diagram of an example computing system that may be used to implement example embodiments described herein;

FIG. 3A is a block diagram illustrating an example implementation of a system for federated learning using a parameterized optimization algorithm, in accordance with examples of the present disclosure;

FIG. 3B is a block diagram illustrating another example implementation of a system for federated learning using a parameterized optimization algorithm, in accordance with examples of the present disclosure;

FIGS. 4A-4C are block diagrams illustrating example embodiments of the optimization parameters update computation block, in accordance with examples of the present disclosure;

FIGS. 5A and 5B are flowcharts illustrating example methods that may be performed using the example system of FIG. 3A, in accordance with examples of the present disclosure; and

FIGS. 6A and 6B are flowcharts illustrating example methods that may be performed using the example system of FIG. 3B, in accordance with examples of the present disclosure.

Similar reference numerals may have been used in different figures to denote similar components.

### DETAILED DESCRIPTION

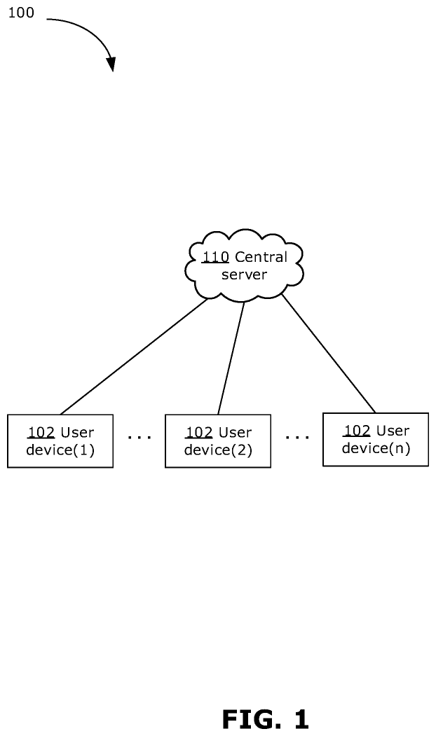

In example embodiments disclosed herein, methods and systems for training a model related to a task (hereinafter referred to as “model”) using federated learning are described that use a parameterized optimization algorithm for updating the parameters of the model during training. The parameters of the optimization algorithm (referred to herein as “optimization parameters”) may also be learned using machine learning. Examples of the present disclosure may be considered implementation of learning to optimize (L2O) in the context of federated learning. Examples of the present disclosure may enable a model to be collaboratively trained using local data from multiple users, while helping to ensure data privacy and to reduce communication costs compared to existing federated learning methods. To assist in understanding the present disclosure, FIG. 1 is first discussed.

FIG. 1 illustrates an example system 100 that may be used to implement examples of federated learning which uses a parameterized optimization algorithm for optimizing a model related to task, as discussed herein. The system 100 has been simplified in this example for ease of understanding; generally, there may be more entities and components in the system 100 than that shown in FIG. 1.

The system 100 includes a plurality of user devices 102 (user device(1) 102 to user device(n) 102, generally referred to as user device 102), each of which collect and store respective sets of local data (also referred to as user data). It should be understood that user devices 102 may alternatively be referred to as clients, client devices, edge devices, nodes, terminals, consumer devices, or electronic devices, among other possibilities. That is, the term “user device” is not intended to limit implementation in a particular type of device or in a particular context.

Each user device 102 may independently be an end user device, a network device, a private network, or other singular or plural entity that stores a set of local data, which is private data. In the case where a user device 102 is an end user device, the user device 102 may be or may include such devices as a client device/terminal, user equipment/device (UE), wireless transmit/receive unit (WTRU), mobile station, fixed or mobile subscriber unit, cellular telephone, station (STA), personal digital assistant (PDA), smartphone, laptop, computer, tablet, wireless sensor, wearable device, smart device, machine type communications device, smart (or connected) vehicles, or consumer electronics device, among other possibilities. In the case where a user device 102 is a network device, the user device 102 may be or may include a base station (BS) (erg eNodeB or gNodeB), router, access point (AP), personal basic service set (PBSS) coordinate point (PCP), among other possibilities. In the case where a user device 102 is a private network, the user device 102 may be or may include a private network of an institute (e.g., a hospital or financial institute), a retailer or retail platform, a company's intranet, etc.

In the case where a user device 102 is an end user device, the local data at the user device 102 may be data that is collected or generated in the course of real-life use by user(s) of the user device 102 (e.g., captured images/videos, captured sensor data, captured tracking data, etc.). In the case where a user device 102 is a network device, the local data at the user device 102 may be data that is collected from other end user devices that are associated with or served by the network device. For example, a user device 102 that is a BS may collect data from a plurality of user devices (e.g., tracking data, network usage data, traffic data, etc.) and this may be stored as local data on the BS.

Regardless of the form of the user device 102, the data collected and stored by each user device 102 as local data (i.e. user data) is considered to be private data (e.g., restricted to be used only within a private network if the user device 102 is a private network, or is considered to be personal data if the user device 102 is an end user device), and it is generally desirable to ensure privacy and security of the user data at each user device 102.

Each user device 102 can run a machine learning algorithm to update parameters of a model using the local data (e.g., user data that is generated and/or stored locally on the user device 102). For the purposes of the present disclosure, running a machine learning algorithm at a user device 102 means executing computer-readable instructions of a machine learning algorithm to update parameters of a model (which may be approximated using a neural network). For generality, there may be n user devices 102 (n being any integer larger than 1).

In the example of FIG. 1, the user devices 102 communicate with a central server 110 (also referred to as a central node). The communication between each user device 102 and the central server 110 may be via any suitable network (e.g., the Internet, a P2P network, a WAN and/or a LAN) and may be a public network.

Although referred to in the singular, it should be understood that the central server 110 may be implemented using one or multiple servers. For example, the central server 110 may be implemented as a server, a server cluster, a distributed computing system, a virtual machine, or a container (also referred to as a docker container or a docker) running on an infrastructure of a datacenter, or infrastructure (e.g., virtual machines) provided as a service by a cloud service provider, among other possibilities. Generally, the central server 110 may be implemented using any suitable combination of hardware and software, and may be embodied as a single physical apparatus (e.g., a server) or as a plurality of physical apparatuses (e.g., multiple servers sharing pooled resources such as in the case of a cloud service provider). As such, the central server 110 may also generally be referred to as a computing system or processing system.

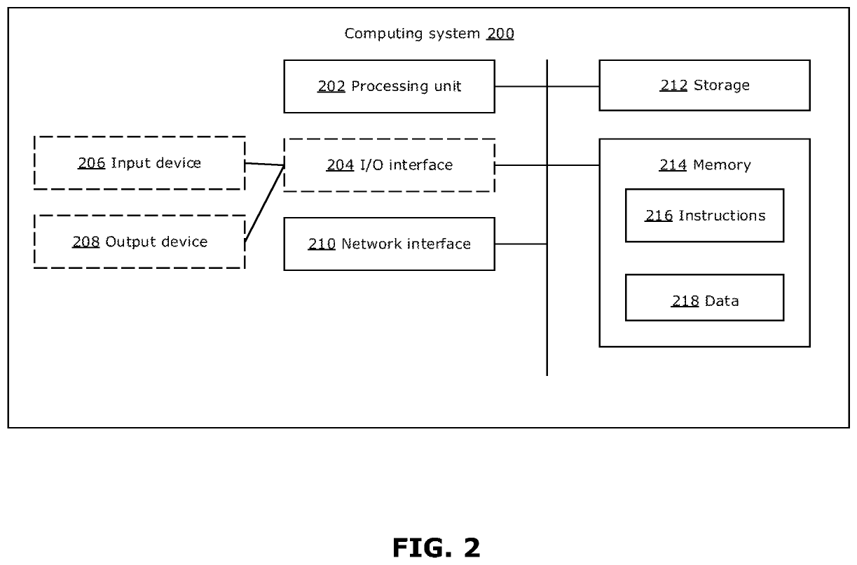

FIG. 2 is a block diagram illustrating a simplified example computing system 200, which may be used to implement the central server 110 or to implement any of the user devices 102 (e.g., in the form of an end user device). Other examples suitable for implementing embodiments described in the present disclosure may be used, which may include components different from those discussed below. Although FIG. 2 shows a single instance of each component, there may be multiple instances of each component in the computing system 200.

The computing system 200 may include one or more processing units 202, such as a processor, a microprocessor, a digital signal processor, an application-specific integrated circuit (ASIC), a field-programmable gate array (FPGA), a dedicated logic circuitry, a dedicated artificial intelligence processor unit, a tensor processing unit, a neural processing unit, a hardware accelerator, or combinations thereof.

The computing system 200 may also include one or more optional input/output (I/O) interfaces 204, which may enable interfacing with one or more optional input devices 206 and/or optional output devices 208. In the example shown, the input device(s) 206 (e.g., a keyboard, a mouse, a microphone, a touchscreen, and/or a keypad) and output device(s) 208 (e.g., a display, a speaker and/or a printer) are shown as optional components of the computing system 200. In some examples, one or more input device(s) 206 and/or output device(s) 208 may be external to the computing system 200. In other example embodiments, there may not be any input device(s) 206 and output device(s) 208, in which case the I/O interface(s) 204 may not be needed.

The computing system 200 may include one or more network interfaces 210 for wired or wireless communication with other entities of the system 100. For example, if the computing system 200 is used to implement the central server 110, the network interface(s) 210 may be used for wired or wireless communication with the user devices 102; if the computing system 200 is used to implement a user device 102, the network interface(s) 210 may be used for wired or wireless communication with the central server 110 (and optionally with one or more other user devices 102). The network interface(s) 210 may include wired links (e.g., Ethernet cable) and/or wireless links (e.g., one or more antennas) for intra-network and/or inter-network communications.

The computing system 200 may also include one or more storage units 212, which may include a mass storage unit such as a solid state drive, a hard disk drive, a magnetic disk drive and/or an optical disk drive.

The computing system 200 may include one or more memories 214, which may include a volatile or non-volatile memory (e.g., a flash memory, a random access memory (RAM), and/or a read-only memory (ROM)). The non-transitory memory(ies) 214 may store instructions 216 for execution by the processing unit(s) 202, such as to carry out example embodiments described in the present disclosure. The memory(ies) 214 may include other software instructions, such as for implementing an operating system and other applications/functions. In some example embodiments, the memory(ies) 214 may include software instructions 216 for execution by the processing unit(s) 202 to implement a parameterized optimization algorithm, as discussed further below. The memory(ies) 214 may also store data 218, such as values of weights of a neural network.

In some example embodiments, the computing system 200 may additionally or alternatively execute instructions from an external memory (e.g., an external drive in wired or wireless communication with the server) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. It should be understood that, unless explicitly stated otherwise, references to computer-readable medium in the present disclosure is intended to exclude transitory computer readable medium.

As noted above, federated learning is a machine learning technique that enables the user devices 102 to participate in learning a model related to a task (e.g., a global model or a collaborative model) without having to share their local data (i.e. user data) with the central server 110 or with other user devices 102. In this way, federated learning may help to ensure privacy of the local data (i.e. user data) (which, in many cases, may contains privacy-sensitive information such as personal photos or health data) while providing user devices 102 with the benefits of a model related to a task that is trained using large amounts of data.

Although federated learning may be considered a form of distributed optimization, federated learning is characterized by certain features that differentiate federated learning from other distributed optimization methods. One differentiating feature is that the number of user devices 102 (or nodes) that participate in federated learning is typically much higher than the number of user devices (or nodes) that participate in distributed optimization (e.g., hundreds of user devices compared to tens of user devices). Other differentiating features include a larger number of “straggler” devices (i.e., devices that are significantly slower to communicate with the central node 110 as compared to other user devices 102) and a larger variation in the amount of user data at each user device 102 (e.g., differing by several orders of magnitude) compared to distributed optimization. An important differentiating feature is that, in federated learning, the user data are typically non-IID (IID meaning “independent and identically-distributed”), meaning the user data of different user devices 102 are unique and distinct from each other, and it may not be possible to infer the characteristics or a distribution of the user data at any one user device 102 based on the user data of any other user device 102. The non-IID nature of the user data means that many (or most) of the methods that have been developed for distributed optimization are ineffective in federated learning.

To help understand how federated learning is used to train a model related to a task, it is useful to discuss a well-known approach to federated learning, commonly referred to as “FederatedAveraging” or FedAvg (e.g., as described by McMahan et al. “Communication-efficient learning of deep networks from decentralized data” AISTATS, 2017), although it should be understood that the present disclosure is not limited to the FedAvg approach.

In FedAvg, a model related to a task (referred to as a “global model”) is learned over several rounds of training. At the beginning of each round, the central server 110 sends the parameters of the global model (e.g., weights of the layers of the neural network that approximate the global model) to a fraction of the user devices 102. Each user device 102 that receives a copy of the parameters of the global model (also referred to as the model parameters) uses the received parameters to update its own model related to the task (the model that is local to the user device 102 may be referred to as a “local model”). The user device 102 then further trains the local model using its own user data to update the parameters of the local model (e.g., using stochastic gradient descent). Information about the updated parameters of the local model are sent back to the central server 110 by the user devices 102, typically in the form of gradients. The central server 110 aggregates the received information to update the parameters of the global model. In the case of FedAvg, the update is performed by averaging the received gradients and adding the average of the received gradients to the current model parameters. Although different federated learning approaches may have variations (e.g., update the parameters of the global model in different ways, share updates from user devices 102 in different ways, etc.), typically the flow of information in each round of training is the same or very similar (i.e., involving communication of the parameters of the global model from the central server 110 to the user devices 102, then a communication of information about the updated model parameters to the global model from the user device 102 to the central server 110).

The cost associated with the communication of the model parameters and information about the updated model parameters in each round of training (e.g., the usage of network resources such as bandwidth; the usage of memory and processing power at the user devices 102 to process received data and transmit data) is a challenge that may limit practical application of federated learning in real-world applications. For example, many user devices may rely on low-throughput communication channels, such as local WiFi networks. Examples of the present disclosure may help to reduce the communication cost associated with federated learning by enabling a model to be learned in fewer rounds of training (i.e., the parameters of the model converge faster to some set of values so that the model achieves an acceptable performance level). In particular, the present disclosure uses a parameterized optimization algorithm to update the model parameters, where the optimization parameters of the optimization algorithm may be learned (using various machine learning-based methods) during training of the model.

In general, existing federated learning methods rely on a manually selected or manually designed optimization algorithm that is used to update the model parameters (e.g., FedAvg uses an averaging method that has been manually designed to update the model parameters). In general, manually selecting the correct optimization algorithm to use is a challenging task which may require laborious iterations via trial-and-error, and may be reliant on the skill and knowledge of the human engineer. As well, such manually selected optimization algorithms are typically fixed once selected, and cannot be easily adapted. A manually selected optimization algorithm may also be sub-optimal, with the result that the parameters of the model may converge too slowly (thus increasing communication costs).

Learning to optimize (L2O) is an area in machine learning, in which the optimization algorithm is itself learned. However, there has not been any successful implementation of L2O in federated learning. A challenge to implementation of L2O in practice is that it is necessary to first parameterize the optimization algorithm in such a way that the space to be searched (defined as the space of all possible optimization algorithms resulting from all possible values of the optimization parameters) is both expressive and efficiently searchable. Expressivity means that different optimization algorithms (e.g., including existing known optimization algorithms) should be recovered by changing the parameters of the parameterized optimization algorithm. Efficiently searchable means that a final (optimal) set of values for the parameters of the parameterized optimization algorithm should be found using as few search attempts as possible.

A unifying framework for federated learning has been proposed (e.g., described by Malekmohammadi et al., “An operator splitting view of federated learning” arXiv, 2021, which is hereby incorporated by reference). It has been shown by Malekmohammadi et al. that most existing optimization algorithms used in federated learning can be recovered from this unifying framework using different parameter values. The unifying framework may thus be referred to as a parameterized optimization algorithm.

To assist in understanding the parameterized optimization algorithm, some discussion of optimization algorithms in federated learning is first provided. In general, federated learning may be formulated as a way to solve the problem of finding an optimal x that minimizes some loss function ƒᵢ(x) for all i, where x represents the learned model (e.g., the parameter values of the learned model) and the loss function ƒᵢ(x) represents the performance of the learned model for each i-th user device. Mathematically, this may be represented as a consensus problem:

$${min}_{{x}_{1} , … , {x}_{n}} {\sum }_{i} {f}_{i} ( {x}_{i} )$$

subject to the constraint x₁=x₂= . . . =xₙ (i.e., the parameter values of the model are the same for all user devices, thus requiring “consensus”).

Typically, this problem is difficult to solve (e.g., too computationally intensive for practical application). Instead of solving this problem directly, the consensus problem is split into smaller sub-problems that are solved iteratively by first finding the xᵢ that minimizes ƒᵢ(xᵢ) for each i, then projecting the solutions (i.e., xᵢ for all values of 1=1, . . . , n) to the consensus set C (which is defined as the set C={(x₁, . . . , xₙ)|x₁= . . . =xₙ}). In the

The parameterized optimization algorithm described by Malekmohammadi et al. splits the problem into the following parameterized equations:

zₜ₊₁=(1−αₜ)uₜ+αₜP_{F}^{η}(uₜ) (1)

wₜ₊₁=(1−βₜ)zₜ₊₁=βₜP_{c}(zₜ₊₁) (2)

uₜ₊₁=(1−γₜ)uₜ+γₜwₜ₊₁ (3)

where zₜ₊₁, wₜ₊₁, uₜ₊₁ ∈ [symbol] ^{d} are auxiliary variables, the subscript t+1 is the index for the t-th round of training, z=[z¹, . . . , z^{N}] (where zⁱ denotes the auxiliary variable for the i-th user device 102), w=[w¹, . . . , w^{N}] (where wⁱ denotes the auxiliary variable for the i-th user device 102), u=[u¹, . . . , u^{N}] (where uⁱ denotes the auxiliary variable for the i-th user device 102), P_{F}^{η}=[P_{f1}^{η}, . . . , P_{fn}^{η}] is a vector of proximal maps (further defined below), and P_{c}(z) is the projection of z onto the consensus set C. α, β and γ are parameters that can be learned. Although, mathematically speaking, the variables z, w and u do not necessarily have meaning outside of their use as auxiliary variables in the parameterized optimization algorithm (as represented by equations (1)-(3)), it is possible to give some conceptual meaning to these variables based on their use in present disclosure. For example, because z is computed based on a weighting of the proximal map, z may be referred to as a weighted proximal map (although it should be understood that this is a conceptual label and is not necessarily the strict mathematical definition or meaning of z). Similarly, because u is used as the update to the model 106 at each user device 102, u may be referred to as the user-specific model parameters or user-specific model update (although it should be understood that this is a conceptual label and is not necessarily the strict mathematical definition or usage of u).

P_{fi}^{η} is the proximal map of the i^{th} user device 102 having a defined loss function ƒᵢ, and can be defined as:

$${P}_{fi}^{η} ( y ) = arg {min}_{x} {f}_{i} ( x ) + \frac{1}{2 η} {‖ x - y ‖}_{2}^{2}$$

where η is a hyperparameter that is designed to find a solution that is closer to the consensus set, and ƒᵢ is the locally defined loss function for the i-th user device 102 (i.e., each user device 102 may have a respective defined loss function, which may or may not be different from each other). The proximal map is a well-studied technique in mathematical optimization. In general, the proximal map (also referred to as a proximal operator or projection operator) may be thought of as a function that aims to minimize the value of the loss function ƒᵢ, while at the same time minimizing the distance from the point γ.

Projection onto the consensus set C for vector z=[z¹, . . . , z^{N}] is defined as:

$${P}_{C} ( z ) = {( \sum {H}_{i} )}^{- 1} ( {\sum }_{i}^{n} {H}_{i} {z}^{i} )$$

for some positive definite matrix H, (e.g., the identity matrix). It may be noted that projection to a consensus set C using the Euclidean norm (also referred to as L2 norm) may be equivalent to taking a simple average of all zⁱ.

It has been found that various different federated learning algorithms that have been previously proposed can be recovered using the parameterized equations described above with certain selected values of the parameters α, β and γ. For example, it has been found that FedAvg is recovered by selecting α, β and γ to each be equal to 1 (i.e., [α, β, γ]=[1,1,1]) in the parameterized equations.

Using the parameterized optimization algorithm (e.g., implemented using the parameterized equations described above), it is possible to adapt the optimization algorithm in federated learning to different applications. For example, one set of values for the parameters α, β and γ may result in faster speed of convergence of the learned model, whereas another set of values may result in a learned model that is more stable (e.g., more likely to provide good performance even if user data fluctuates widely). In the present disclosure, the parameters of the parameterized optimization algorithm (i.e., α, β and γ) may be referred to as optimization parameters to distinguish from the model parameters (e.g., the weights of the neural network used to approximate the model).

However, developing a method to learn the optimization parameters of a parameterized optimization algorithm in federated learning is not trivial. For example, it is necessary to define the feedback that will be used to update the optimization parameters in each round of training in federated learning. Further, it is necessary to define the method by which the optimization parameters of a parameterized optimization algorithm should be updated. The present disclosure describes examples that enable implementation of the parameterized optimization algorithm in federated learning, including various methods for learning the optimization parameters of the parameterized optimization algorithm, with different possible implementations in the user device 102 and the central server 110.

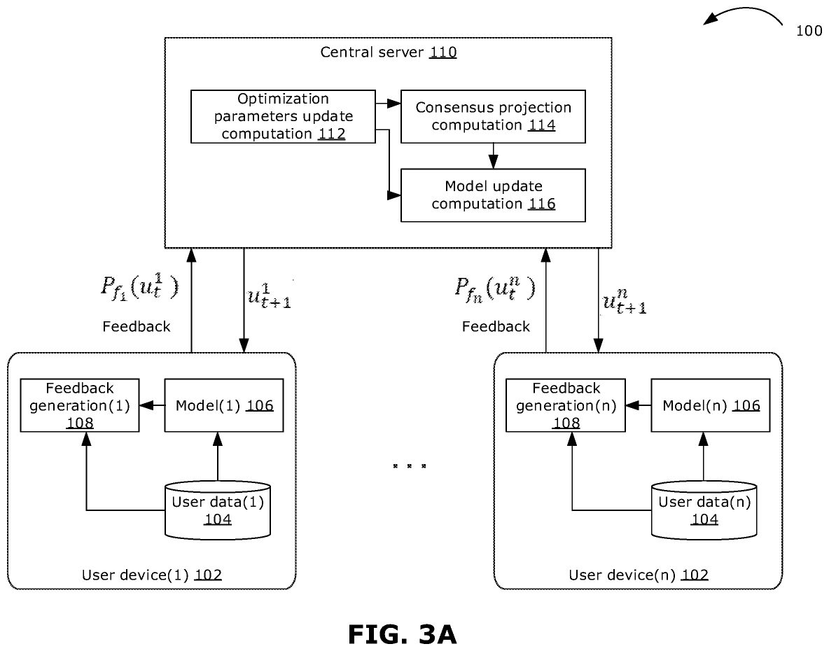

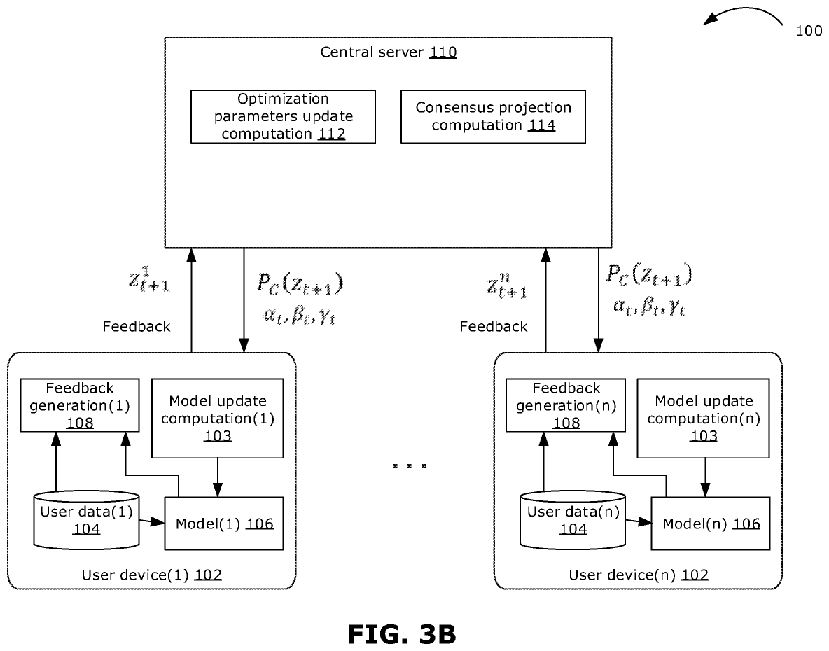

FIG. 3A is a block diagram illustrating more details of the system 100, including details that may be used to implement federated learning using the parameterized optimization algorithm as disclosed herein. In particular, FIG. 3A illustrates an example in which model updates are computed by the central server 110 (also referred to as server-side model update).

For simplicity, the central server 110 has been illustrated as a single server (e.g., implemented using an instance of the computing system 200). However, it should be understood that the central server 110 may actually be a virtual server or virtual machine that is implemented by pooling resources among a plurality of physical servers, or may be implemented using a virtual machine or container (also referred to as a docker container or a docker) within a single physical server, among other possibilities.

In the example shown, the central server 110 includes an optimization parameters update computation block 112, a consensus projection computation block 114 and a model update computation block 116. The computation blocks 112, 114, 116 may all be implemented in the form of software instructions (e.g., algorithms) stored in a memory of the central server 110 and executed by one or more processing units of the central server 110. The optimization parameters update computation block 112 updates the values of the optimization parameters (i.e., updates the values of α, β and γ) of the parameterized optimization algorithm based on the feedback from the user devices 102. Various methods may be used to update the optimization parameters of the parameterized optimization algorithm, as discussed further below. The consensus projection computation block 114 uses feedback from the user devices 102 to compute a projection onto the consensus set (i.e., computes P_{c}(zₜ₊₁)). The model update computation block 116 computes the updated model parameters (i.e., computes uₜ₊₁=[uₜ₊₁¹, . . . , u₊₁^{N}]) for each respective user device 102. The updated model parameters may be referred to generally as model updates, and may be in the form of updated parameter values (e.g., updated values of the weights of the model) or may be in the form of a differential to be applied to update the model (e.g., gradients to be applied to update the weights of the model). It may be noted that executing the parameterized optimization algorithm described above (where the parameterized optimization algorithm has the updated optimization parameters from the optimization parameters updated computation block 112) may involve executing both the consensus projection computation block 114 and the model update computation block 116. Accordingly, in some examples, the consensus projection computation block 114 and the model update computation block 116 may be implemented as a single functional block that uses (i.e. executes) the parameterized optimization algorithm. Because the parameterized optimization algorithm is based on splitting the consensus problem, the parameterized optimization algorithm may also be referred to as a splitting algorithm (or a splitting update algorithm).

Each user device 102 is shown as having similar configuration, for simplicity. However, it should be understood that different user devices 102 may have different configurations. For example, one user device 102 may have access to multiple different memories storing different sets of user data. In the example shown, each user device 102 stores respective user data 104 (user data(1) 104 to user data(n) 104, generally referred to as user data 104), and includes a respective model 106 (model(1) 106 to model(n) 106, generally referred to as model 106). It may be noted that the model 106 at each user device 102 may be a copy of the global model (i.e., the models 106 are trained in a way that they converge on the same parameters, regardless of the user data 104 at each user device 102) or may be different models (i.e., the models 106 at each user device 102 may converge on different parameters). Each model 106 may be implemented using a respective neural network, the parameters of which (e.g., the values of the weights in the neural network) are updated using the respective update uₜ₊₁ⁱ (e.g., update values of the weights of the respective model 106 using updated weight values) from the central server 110. Each user device 102 also includes a feedback generation block 108 (feedback generation(1) 108 to feedback generation(n) 108, generally referred to as feedback generation block 108) that uses output from its own model 106 and user data 104 to generate feedback to the central server 110. It may be noted that the feedback generation block 108 included in each user device 102 may perform the same computation (i.e., may be implemented using the same algorithm). In each user device 102, the feedback generation block 108 and the model 106 may be implemented in the form of software instructions (e.g., algorithms) stored in a memory of the user device 102 and executed by one or more processing units of the user device 102. The user data 104 may be stored as data in the memory of the user device 102.

The model 106 of each user device 102 may have full access to the respective user data 104 of each user device 102. The feedback that is generated by the feedback generation block 108 may include data representing a current state of the user device 102, and the type of feedback that is provided to the central server 110 may be dependent on the method used by the central server 110 to update the optimization parameters, as discussed further below. In general, the feedback communicated from the user device 102 to the central server 110 may not include any raw user data 104. Each user device 102 also computes its own proximal map using its current model 106 and user data 104 (i.e., P_{fi}(uₜⁱ)) and communicates the proximal map to the central server 110.

In each round of training, each user device 102 communicates a respective proximal map (i.e., the i-th user device 102 computes its own proximal map P_{fi}(uₜⁱ) using the current state (e.g., current value of the weights) of its model 106 and its own user data 104 and transmits the computed proximal map to the central server 110). Each user device 102 also communicates other feedback about its current state (e.g., the current state of its user data 104, the current state of its observed environment, the current state of its model 106, etc.) to the central server 110. The central server 110 uses the feedback to update the optimization parameters of the parameterized optimization algorithm (using a suitable method, as discussed further below). The updated optimization parameters are then used in the parameterized optimization algorithm to compute the model updates uₜ₊ᵢ=[u₊₁¹, . . . , uₜ₊₁^{N}] (note that the parameterized optimization algorithm includes computation of the consensus projection P_{c}(zₜ₊₁)) The model updates are then communicated to each respective user device 102 (i.e., uₜ₊₁ⁱ is transmitted from the central server 110 to the i-th user device 102). It may be noted that in the case where the optimization parameters α, β and γ are all equal to 1, the model update to each user device 102 is simply the consensus projection, meaning that each user device 102 is provided with the same model update (i.e., the model 106 at each user device 102 becomes the same global model).

FIG. 3B is a block diagram illustrating another example implementation of the system 100, which may be used to implement federated learning using the parameterized optimization algorithm as disclosed herein. Compared to FIG. 3A, FIG. 3B illustrates an example in which model updates are computed by each user device 102 (also referred to as user-side model update).

The example of FIG. 3B is similar to FIG. 3A in some aspects, as indicated by the use of the same reference numerals. In the example of FIG. 3B, the model update computation block 103 (model update computation(1) 103 to model update computation(n) 103, generally referred to as model update computation block 103) is implemented at each user device 102, rather than at the central server 110. It may be noted that the model update computation block 103 in each user device 102 may perform the same computation (i.e., may be using (i.e. executing) the same parameterized optimization algorithm).

It may be noted that, although the model update computation block 103 is implemented in each user device 102, in this example only the central server 110 is able to compute the consensus projection P_{c}(zₜ₊ᵢ) because only the central server 110 is a trusted central entity that communicates with all user devices 102. In each round of training, each user device 102 computes zₜ₊₁ⁱ using equation (1) of the parameterized optimization algorithm, and communicates zₜ₊₁ⁱ to the central server 110. Each user device 102 also generates and communicates feedback representing its current state (which may depend on the method used by the optimization parameters update computation block 112 at the central server 110) to the central server 110. The central server 110 uses the received zₜ₊₁ⁱ to compute a consensus projection P_{c}(zₜ₊₁) The central server 110 uses the feedback to update the optimization parameters (using a suitable method, as discussed further below). The updated optimization parameters α, β and γ and the consensus projection P_{c}(zₜ₊ᵢ) are then communicated to each respective user device 102. Each user device 102 then uses the updated optimization parameters α, β and γ and the consensus projection P_{c}(zₜ₊ᵢ) received from the central server 110 to continue the model update computation using equations (2) and (3) of the parameterized optimization algorithm. Each user device 102 then uses the respective computed model update uⁱₜ₊₁ to update the model parameters of its own model 106.

The system 100 illustrated in FIG. 3A provides a centralized implementation, in which each i^{th} user device 102 only stores uₜⁱ and is responsible for computing and communicating its own proximal map P_{fi}^{η}(uₜ₊₁ⁱ) to the central server 110. In return, the central server 110 computes equations (1)-(3) of the parameterized optimization algorithm and communicates model updates uₜ₊₁ⁱ back to each i^{th} user.

The system 100 illustrated in FIG. 3B provides a decentralized implementation, in which equations (1)-(3) of the parameterized optimization algorithm are computed locally at each user device 102, with the exception that the central server 110 computes the consensus projection P_{c}(zₜ₊ᵢ) (which may be conceptually referred to as an averaged model) using zₜ₊₁ⁱ from each i^{th} user device 102. In this implementation, the central server 110 may act as a bridge for synchronization among the user devices 102.

Regardless of the specific implementation (i.e., as illustrated in FIG. 3A or FIG. 3B), after training is completed (e.g., after a convergence condition has been satisfied; for example the model 106 of each user device 102 has converged), there may not be any further communication between each user device 102 and the central server 110. The models 106 may be considered to be trained and may be used to generate predicted outputs during an inference phase. In some examples, there may be periodic (e.g., for a limited amount of time per day), intermittent, or occasional (e.g., in response to some trigger, such as a request from a user device 102) communication between the user devices 102 and the central server 110, to ensure the models 106 are adapted to any changes in the user data 104.

In general, the functions of the central server 110 and the user devices 102 may be implemented using software (e.g., instructions for execution by a processing unit), using hardware (e.g., programmable electronic circuits designed to perform specific functions), or combinations of software and hardware. Although FIGS. 3A and 3B show certain computation blocks, it should be understood that this is only for the purpose of illustration and is not intended to be limiting. There may be greater or fewer computation blocks implemented in the central server 110 and/or user devices 102, for example. Further, functions that are described as being performed by one computation block may instead be performed by a different computation block.

As previously described, the optimization parameters update computation block 112 uses feedback from each user device 102 to update the optimization parameters (i.e., the values of α, β and γ of the parameterized optimization algorithm represented by equations (1)-(3)). Some example methods that may be used to update the optimization parameters are now described, including: K-armed bandit algorithm; reinforcement learning agent; Bayesian system; and supervised learning algorithm. In some examples, a neural network may be used to update the optimization parameters.

The feedback generation block 108 may generate feedback to the central server 110 depending on the method used to update the optimization parameters. For example, if a K-armed bandit algorithm is used by the optimization parameters update computation block 112, the feedback generation block 108 may compute the loss function ƒᵢ of each user device 102, where the loss function represents the performance of the current state of the model 106 (e.g., the confidence level or error of the model 106 when processing the user data 104). In another example, if a reinforcement learning agent is used by the optimization parameters update computation block 112, the feedback generation block 108 may compute a vector representing the current state of each user device 102 (e.g., representing a current environment of the user device 102).

In general, the feedback generation block 108 may generate feedback that represents the loss landscape (e.g., shape of the loss function) and/or current state of each user device 102. Examples of feedback that may be generated include: the current weight values of the model 106 (or any other data representing the state of the user device 102 at any point) (where the term “point”, in the following discussion, may refer to any point in the space of all possible states of the user device 102; in general, the point may correspond to a time point, or may correspond to a point along any other parameter (e.g., speed, location, etc.) that defines the current state of the user device 102 and its environment); zero-order information (i.e., ƒᵢ at any point); first-order information (i.e., ∇ƒᵢ at any point); second order information (i.e., ∇² ƒᵢ at any point); momentum information (i.e., ∇ƒᵢ(x₂)−∇ƒᵢ(x₁) for two consecutive points); or any other feedback that may be suitable for L2O methods (e.g., gradient, loss function, etc.) (e.g., as shown in Table 1 of Chen et al. “Learning to Optimize: A Primer and A Benchmark” arXiv 2021). Such feedback may be computed by the feedback generation block 108 using a defined loss function of the user device 102 and outputted as a vector or scalar, for example. In general, the feedback generation block 108 is configured to generate feedback that represents appropriate and sufficient data about the real-world environment of each user device 102 to enable the model 106 to be trained to an acceptable level of performance. Further discussion of different possible types of feedback and their appropriate selection and use are provided in Chen et al. cited above.

In some examples, the feedback generation block 108 may be implemented using some algorithm that captures historical data (i.e., from previous time points) as well as the current state of the user device 102. For example, the feedback generation block 108 may be implemented using a long short-term memory (LSTM), recurrent neural network (RNN) or other neural network having an adjustable memory to combine historical data (stored in a memory for an adjustable number of historical time points) with information from the current state of the algorithm. The feedback generation block 108 may be implemented using neural networks that have been trained to generate, from the user data 104, output a feature vector representing a historical trend of the features that are relevant to the task to be performed by the model 106.

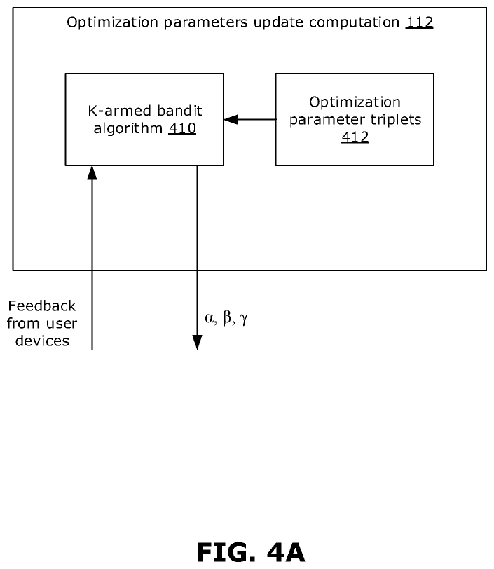

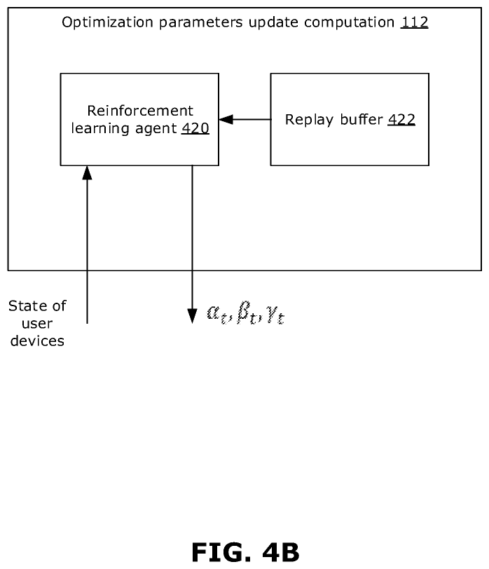

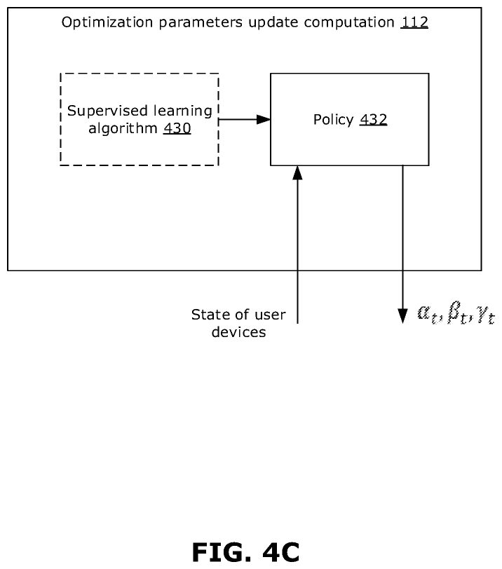

FIG. 4A is a block diagram illustrating an example implementation of the optimization parameters update computation block 112 using a K-armed bandit algorithm.

In this example, the optimization parameters αₜ, βₜ, γₜ of the parameterized optimization algorithm are updated periodically (e.g., once a day, or once an hour) rather than updated continuously throughout the training rounds. In this way, the optimization parameters αₜ, βₜ, γₜ of the parameterized optimization algorithm may be treated as hyperparameters in the sense that the values of the optimization parameters αₜ, βₜ, γₜ are set at the beginning of a period of training (e.g., a defined number of training rounds; or a defined time duration) and are not updated during the training (until the start of the next period of training). The goal of the optimization parameters update computation block 112 is to set the values of the optimization parameters αₜ, βₜ, γₜ to optimize some measure of performance of the model 106 at each user device 102, while reducing the computational cost. An example measure of performance may be the prediction accuracy of the model 106 after it has been updated using the parameterized optimization algorithm over a defined period of training and using a set values for the optimization parameters α, β, γ.

As shown in FIG. 4A, the optimization parameters update computation block 112 may use a K-armed bandit algorithm 410 that selects a set of values for the optimization parameters α, β, γ from some database (e.g., storing a lookup table) of optimization parameter triplets 412. Each stored triplet is a unique combination of values for the optimization parameters α, β, γ, where K is the number of possible combinations of the optimization parameters α, β, γ. At the start of each period of training, the K-armed bandit algorithm 410 selects one set of values for the optimization parameters α, β, γ (e.g., select one row of values from a lookup table) to use to implement the parameterized optimization algorithm at the model update computation block (which may be implemented in the central server 110 or in the user device 102). Then, at the next period of training, the K-armed bandit algorithm 410 uses feedback about the performance of the model 106 at each user device 102 to select a set of values for the optimization parameters α, β, γ (which may be the same or different from the set of values for the optimization parameters α, β, γ selected at the previous period of training). An example of the type of feedback that may be used for selecting the optimization parameters α, β, γ using the K-armed bandit algorithm 410 may include: Σƒᵢ(x) where ƒᵢ is the loss function defined at each user device 102 and x is the final model 106 at the end of a period of training; an average of model accuracy across all models 106 at all user devices 102 at the end of a period of training; or variance of errors across all models 106 at all user devices 102 at the end of a period of training; among other possibilities. It should be noted that, in FIG. 4A, the optimization parameters α, β, γ are shown without subscript, to indicate that the set of values for the optimization parameters α, β, γ are set for a defined period of training and are not updated per round of training. However, this does not mean that the set of values for the optimization parameters α, β, γ are manually selected or are constants; rather, the set of values for the optimization parameters α, β, γ are updated periodically using an algorithm.

Any suitable K-armed bandit algorithm 410 may be used, including upper confidence bound (UCB) algorithms, Thompson sampling algorithms, and others. For example, using the UCB algorithm the K-armed bandit algorithm 410 may select, from the optimization parameter triplets 412, a set of values for the optimization parameters α, β, γ that are associated with the highest upper confidence bound. It may be noted that the optimization parameter triplets 412, instead of being stored as discrete values (e.g., in a lookup table), may be sampled from a continuous range. In such examples, the K-armed bandit algorithm 410 may be an infinitely many-armed bandit algorithm. An example infinitely many-armed bandit algorithm is described by Wang et al. “Algorithms for infinitely many-armed bandits” Advances in Neural Information Processing Systems 21 (NIPS 2008).

It may be noted that, compared to some other example implementations of the optimization parameters update computation block 112 disclosed herein, the implementation using the K-armed bandit algorithm 410 may not require any training of the optimization parameters update computation block 112 in advance. That is, the K-armed bandit algorithm 410 may be used to select a set of values for the optimization parameters α, β, γ at the start of each period of training, without having to be first pre-trained on some simulated, experimental or historical data.

An advantage of the example implementation of FIG. 4A is that the K-armed bandit algorithm 410 is computationally simple, and does not require training in advance.

FIG. 4B is a block diagram illustrating an example implementation of the optimization parameters update computation block 112 using a reinforcement learning agent.

In this example, the optimization parameters update computation block 112 implements a reinforcement learning agent 420 that learns a policy to select a set the values for the optimization parameters αₜ, βₜ, γₜ. In general, the policy may be a learned function that maps an input state (i.e., the state of the user devices 102, as represented in the feedback communicated from the user devices 102) to a set of values for the optimization parameters αₜ, βₜ, γₜ. The reinforcement learning agent 420 is an algorithm that uses feedback from each round of training to learn the policy and update the set of values for the optimization parameters αₜ, βₜ, γₜ during the training.

In particular, the reinforcement learning agent 420 learns the policy such that the cumulative reward (or cumulative penalty) is minimized as training progresses. The cumulative reward to be minimized may be defined as follows:

$$Reward = {\sum }_{t} f ( {z}_{t} ) = {\sum }_{t}^{T} {\sum }_{i}^{n} {f}_{i} ( {z}_{t} ) ,$$

where zₜ is the average of all zₜⁱ at time t, and T is a hyperparameter that sets the amount of historical data used to learn the policy.

In each round of training, each user device 102 generates data representing the current state observed by the user device 102. For example, the current state may be computed as ƒᵢ(uₜⁱ) (i.e., the defined loss function of the user device 102) or the slope of the loss function. It should be understood that the reward function may be designed using various techniques known in the field of reinforcement learning and need not be discussed in detail in the present disclosure. The reinforcement learning agent 420 collects the cumulative reward (which is computed based on the state of the user devices 102) and uses the reward to update the policy that is used to set the values of the optimization parameters.

The optimization parameters update computation block 112 may include or may have access to a replay buffer 422, which stores historical feedback from the user devices 102 (e.g., the state data from previous time points). The replay buffer 422 enables the reward to be computed over a number of historical time points. In some examples, the replay buffer 422 may be omitted (e.g., if the reward is computed using only data representing the current state of the user device 102, if historical data is stored elsewhere in the central server 110, or if each feedback from the user device 102 includes both current and historical state data).

The reinforcement learning agent 420 may be at least partially trained in advance (also referred to as offline learning) using simulated, experimental or historical data. This may enable faster learning of the policy (and thus faster convergence of the learned model 106), when the reinforcement learning agent 420 is further trained on real-world data fed back from the user devices 102 during deployment (also referred to as online learning).

Compared to the example of FIG. 4A, the example of FIG. 4B may be more computationally complex, but enables the optimization parameters to be updated during the training process (i.e., does not need to wait until the end of a period of training to update the optimization parameters).

FIG. 4C is a block diagram illustrating an example implementation of the optimization parameters update computation block 112 using supervised learning.

FIG. 4C illustrates a supervised learning algorithm 430 implemented in the optimization parameters update computation block 112. The supervised learning algorithm 430 is used to learn a policy 432 for updating the optimization parameters αₜ, βₜ, γₜ. In general, the policy 432 may be a learned function that maps an input state (i.e., the state of the user devices 102, as represented in the feedback communicated from the user devices 102) to a set of values for the optimization parameters αₜ, βₜ, γₜ. However, unlike the example of FIG. 4B, the policy 432 is learned, using the supervised learning algorithm 430, during training (also referred to as offline learning) prior to application of the policy 432 in real-world deployment and the policy 432 is not further learned during deployment (also referred to as online learning).

The feedback communicated from the user devices 102 may represent a current state observed by the user device 102 (similar to the example of FIG. 4B). In some examples, information about the current state may be extracted by the feedback generation block 108 of each user device 102 using a neural network (e.g., a RNN or a LSTM as discussed above).

The supervised learning algorithm 430 may be any suitable machine learning algorithm that learns the policy 432, for example using backpropagation and gradient descent algorithms to minimize a loss function. The loss function may be defined as follows:

$$L ( ϕ ) = {E}_{f} [ {\sum }_{t = 1}^{T} {λ}_{{t}_{t}} f ( {w}_{t} ) ]$$

where λₜ≥0 are some defined positive weights, ϕ represents the parameters (which are to be learned) of the policy 432 and state-extraction functional blocks (which may be implemented at each user device 102, for example as part of the feedback generation block 108), and E_{ƒ} represents the expectation with respect to some distribution of the loss functions ƒ(zₜ) at each user device 102. Generally, if there are m functions in a distribution of functions, E_{ƒ} may be interpreted as a simple average of the functions' value for some point x in the domain of the functions (i.e.,

$${E}_{f} = \frac{1}{m} {\sum }_{i} {f}_{i} ( x )$$

for some x). It should be noted that this interpretation of E_{ƒ} may be simplistic and is not intended to limit the present disclosure. In general, the loss function L(ϕ) may be defined in such a way that minimizing the loss function L(ϕ) results in minimizing the expected value of a weighted sum of the loss functions ƒ(wₜ) of all the user devices 102.

During the training phase, the supervised learning algorithm 430 learns the parameters ϕ of the policy 432 with the goal of minimizing L(ϕ), using some set of training data. The set of training data that is used during the training may be selected based on the model 106 that is to be trained in deployment. For example, if the goal is to train a model 106 that is a convolutional neural network (CNN), the set of training data for learning the policy 432 may include CNNs with different architectures, different width and depth, different type of activations, etc. For example, if the goal is to train a model 106 to perform face recognition, then the policy 432 may be learned by training a policy neural network that approximates the policy 432 to find the optimization parameters for the parameterized optimization algorithm which is similar to a optimization algorithm that is used during training of a similar but smaller model. In general, the architecture of the similar but smaller model (also referred to as a “test” model or “toy” model) that is used during the training of the smaller model should be similar or the same as the actual model 106 that is to be trained.

After the policy 432 has been learned (e.g., after a defined number of training iterations using the set of training data, or after the parameters ϕ of the policy 432 converge), the policy 432 may be fixed. The learned policy 432 may then be used to update the optimization parameters αₜ, βₜ, γₜ during training of the model 106 using real-world data. In some examples, further training or tuning of the policy 432 may be performed periodically (e.g., daily or weekly) or occasionally (e.g., if faster convergence of the models 106 is desired).

Compared to the example of FIG. 4B, the example of FIG. 4C learns the policy 432 for updating the optimization parameters entirely offline (i.e., using training data, before training the model 106 on real-world data).

FIGS. 4A-4C illustrate some examples for implementing the optimization parameters update computation block 112, which may be used for implementation in the example of FIG. 3A or FIG. 3B. It should be understood that other methods may be used by the optimization parameters update computation block 112 to compute updates to the optimization parameters.

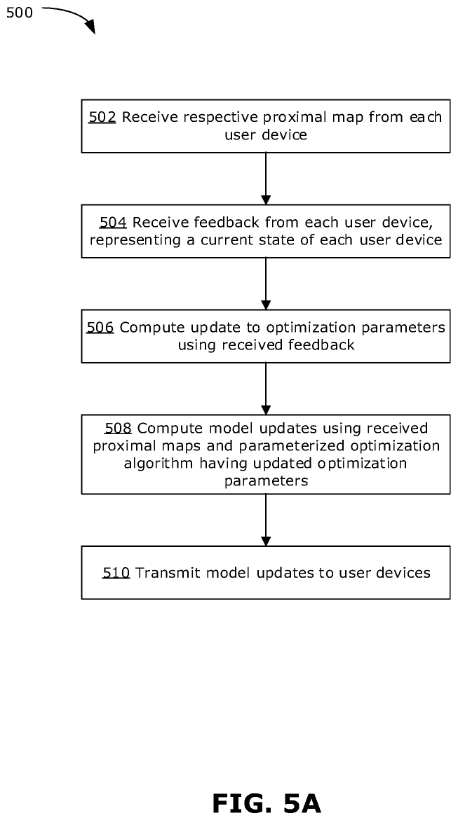

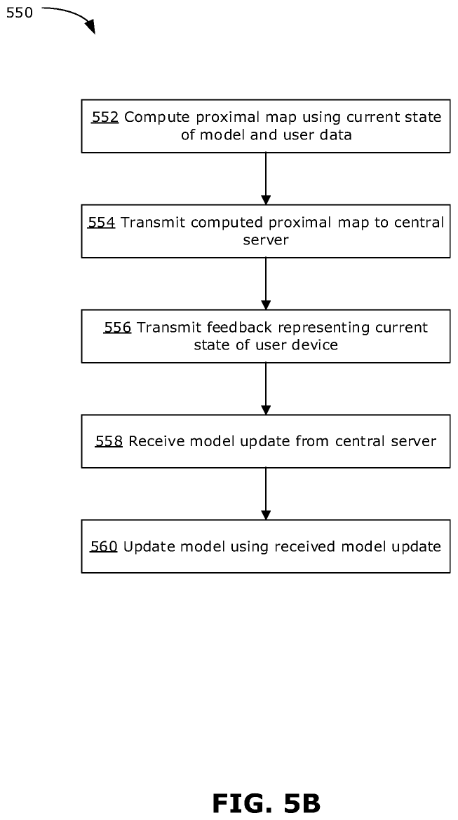

FIG. 5A is a flowchart illustrating an example method 500, which may be performed by the central server 110 in the example of FIG. 3A. The method 500 may illustrate steps that are performed by the central server 110 in a round of training.

At 502, respective proximal maps are received from each user device 102. That is, from each i-th user device 102 the central server 110 receives a respective proximal map P_{fi}(uₜⁱ).

At 504, feedback is also received from each user device 102, representing the current state of each user device 102. The feedback from a given user device 102 may be received together with the proximal map from that user device 102, or may be received separately. As described above, the type of feedback that is received from the user devices 102 may be dependent on the method used by the central server 110 to update the optimization parameters. The type of feedback that is received may also be dependent on the task to be performed by the model 106. For example, if the model 106 is to control the operation of a drone and a reinforcement learning agent is used to update the optimization parameters, the feedback that is received may include data about the observed state of the drone (e.g., speed, distance from ground, etc.).

At 506, an update to the optimization parameters is computed using the received feedback. That is, the values of the optimization parameters α, β and γ are all updated. The optimization parameters may be updated using, for example, a K-armed bandit algorithm, a reinforcement learning agent implementing a learned policy, or a pre-trained policy (e.g., as described above with respect to FIGS. 4A-4C). It should be noted that, in the case of a K-armed bandit algorithm, the optimization parameters may be updated only in the first round of training in a defined period of training (e.g., updated once per day) and are fixed thereafter until the next period of training.

At 508, model updates are computed using the received proximal maps and the parameterized optimization algorithm having the updated optimization parameters. That is, the proximal maps P_{fi}(uₜⁱ) and updated values of the optimization parameters α, β and γ are used in the parameterized optimization algorithm represented by equations (1)-(3) as described above. The output of equations (1)-(3) is a set of model updates uₜ₊₁=[uₜ₊₁¹, . . . , uₜ₊₁^{N}] where the i-th model update uⁱₜ₊₁ is the update to the model 106 of the i-th user device 102.

At 510, the models updates are transmitted to the user devices 102. Specifically, the central server 110 transmits the i-th model update uₜ₊₁ⁱ to the i-th user device 102.

FIG. 5B is a flowchart illustrating an example method 550, which may be performed by one of the user devices 102 in the example of FIG. 3A. The method 550 may illustrate steps that are performed by the user device 102 in a round of training.

At 552, a proximal map is computed using the current state of the model 106 and the user data 104 stored at the user device 102. That is, the user device 102 computes its own proximal map using its own model 106 and user data 104.

At 554, the user device 102 transmits the computed proximal map to the central server 110.

At 556, the user device 102 transmits feedback to the central server 110 representing the current state of the user device 102. In some examples, steps 554 and 556 may be performed using a single transmission (i.e., the computed proximal map may be transmitted together with the feedback). In some examples, prior to transmitting the feedback the user device 102 may compute the feedback using, for example, sensed data about its environment. In some examples, the user device 102 may use a neural network (e.g., a RNN or a LSTM) to generate feedback representing the state of the user device 102.

At 558, a model update is received from the central server 110. The model update may, for example, in the form of a gradient that should be applied to the parameters (e.g., weight values) of the model 106 or in the form of updated parameter values.

At 560, the model 106 is updated using the received model update. For example, if the received model update is a gradient, then the gradient may be added to the current parameter values (e.g., weight values) of the model in order to update the model 106; or if the received model update are updated parameter values, then the parameters of the model 106 may be updated with the updated parameter values. The updated model 106 (i.e., having the updated parameters) may then be further trained using the local data 104 at the user device 102.

The methods 500 and 550 may illustrate a single round of training in the example system 100 of FIG. 3A. The methods 500 and 550 may be repeated until the models 106 of the user devices 102 converge (e.g., the model updates computed using the parameterized optimization algorithm converge).

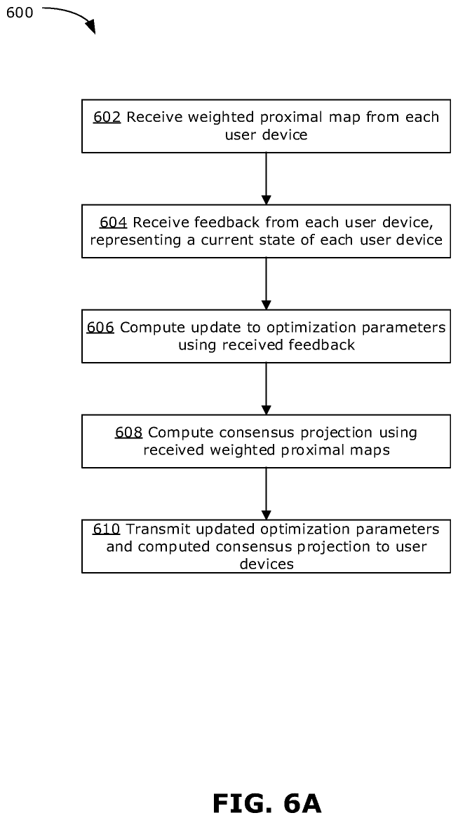

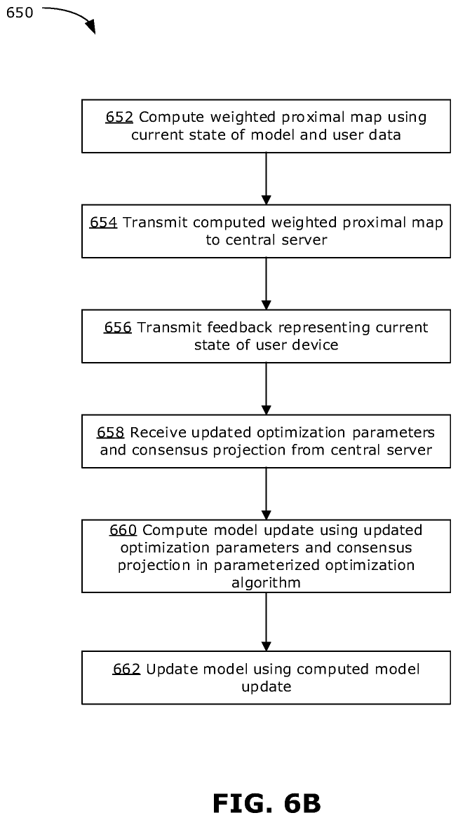

FIG. 6A is a flowchart illustrating an example method 600, which may be performed by the central server 110 in the example of FIG. 3B. The method 600 may illustrate steps that are performed by the central server 110 in a round of training.

At 602, respective weighted proximal maps are received from each user device 102. That is, from each i-th user device 102 the central server 110 receives a respective weighted proximal map zₜ₊₁ⁱ.

At 604, feedback is also received from each user device 102, representing the current state of each user device 102. The feedback from a given user device 102 may be received together with the weighted proximal map from that user device 102, or may be received separately. As described above, the type of feedback that is received from the user devices 102 may be dependent on the method used by the central server 110 to update the optimization parameters. The type of feedback that is received may also be dependent on the task to be performed by the model 106. For example, if the model 106 is to control the operation of a drone and a reinforcement learning agent is used to update the optimization parameters, the feedback that is received may include data about the observed state of the drone (e.g., speed, distance from ground, etc.).

At 606, an update to the optimization parameters is computed using the received feedback. That is, the values of the optimization parameters α, β and γ are all updated. The optimization parameters may be updated using, for example, a K-armed bandit algorithm, a reinforcement learning agent implementing a learned policy, or a pre-trained policy (e.g., as described above with respect to FIGS. 4A-4C). It should be noted that, in the case where a K-armed bandit algorithm is used, the optimization parameters may be updated only in the first round of training in a defined period of training (e.g., updated once per day) and are fixed thereafter until the next period of training.

At 608, the consensus projection is computed using the received weighted proximal maps. That is, the consensus projection P_{c}(zₜ₊ᵢ) is computed by projecting zₜ₊ᵢ=[z₊₁¹, . . . , zₜ₊₁^{N}] onto the consensus set C, where the consensus set is defined as the set where C={z₁, . . . , zₙ)|z₁= . . . =zₙ}.

At 610, the updated optimization parameters and the computed consensus projection are transmitted to the user devices 102. It may be noted that the updated optimization parameters and the consensus projection are the same for all user devices 102. It should be noted that, in the case where a K-armed bandit algorithm is used to update the optimization parameters, the optimization parameters may be updated only in the first round of training in a defined period of training (e.g., updated once per day) and thus the updated optimization parameters may be transmitted to the user devices 102 only in the first round of training in the defined period of training.

FIG. 6B is a flowchart illustrating an example method 650, which may be performed by one of the user devices 102 in the example of FIG. 3B. The method 650 may illustrate steps that are performed by the user device 102 in a round of training.

At 652, a weighted proximal map is computed using the current state of the model 106 and the user data 104 stored at the user device 102. For example, the i-th user device 102 first computes its own proximal map P_{fi}(uₜⁱ) using the current state (e.g., current value of the weights) of its model 106 and its own user data 104, then uses the computed proximal map in equation (1) of the parameterized optimization algorithm to compute zₜ₊₁ⁱ In this example, since the user device 102 has not yet received updated optimization parameters from the central server 110, equation (1) may be computed using the current (i.e., not yet updated) optimization parameters.

At 654, the user device 102 transmits the computed weighted proximal map to the central server 110.

At 656, the user device 102 transmits feedback to the central server 110 representing the current state of the user device 102. In some examples, steps 554 and 556 may be performed using a single transmission (i.e., the computed proximal map may be transmitted together with the feedback). In some examples, prior to transmitting the feedback the user device 102 may compute the feedback using, for example, sensed data about its environment. In some examples, the user device 102 may use a neural network (e.g., a RNN or a LSTM) to generate feedback representing the state of the user device 102.

At 658, updated optimization parameters and a consensus projection are received from the central server 110. As noted above, if the central server 110 uses a K-armed bandit algorithm to update the optimization parameters, the updated optimization parameters may be received from the central server 110 only in the first round of training in a defined period of training (e.g., may be updated only once per day).

At 660, a model update is computed using the received updated optimization parameters and the consensus projection. For example, the i-th user device 102 uses its own previously computed zₜ₊₁ⁱ together with the received updated optimization parameters α, β and γ and the received consensus projection P_{c}(zₜ₊₁) in equations (2) and (3) of the parameterized optimization algorithm to compute its own model update uₜ₊₁ⁱ.

At 662, the model 106 is updated using the computed model update. For example, if the computed model update is a gradient, then the gradient may be added to the current parameter values (e.g., weight values) of the model in order to update the model 106; or if the computed model update are updated parameter values, then the parameters of the model 106 may be updated with the updated parameter values. The updated model 106 (i.e., having the updated parameters) may then be further trained using the local data 104 at the user device 102.

The methods 600 and 650 may illustrate a single round of training in the example system 100 of FIG. 3B. The methods 600 and 650 may be repeated until the models 106 of the user devices 102 converge (e.g., the model updates computed using the parameterized optimization algorithm converge).

In various example embodiments, the present disclosure describes methods and systems for performing federated learning using a parameterized optimization algorithm. The present disclosure describes examples that enables L2O in the context of federated learning.

Compared to other existing federated learning methods, example embodiments discussed herein may be better able to adapt to different applications, user scenarios and/or changing user data. For example, using a parameterized optimization algorithm may enable the federated learning system to achieve faster convergence of a learned model, may help to ensure greater fairness (e.g., the performance of the learned model at any user device is not significantly worse than that at any other user device), may help to improve robustness of the learned model and/or may help to reduce model variability/instability during training.

Because federated learning enables training of a model related to a task without violating the privacy of the clients, examples of the methods and systems of the present disclosure may be used for training a model using machine learning, without compromising data privacy. Accordingly, the example embodiments of the methods and systems disclosed herein may enable practical application of machine learning in settings where privacy is important, such as in health settings, or other contexts where there may be legal obligations to ensure privacy.

Further, because examples of the methods and systems of the present disclosure may enable a model related to a task to reach convergence faster (i.e., the model related to the task converges faster and therefore requires fewer additional rounds of training), the communication costs associated with federated learning may be reduced. This may enable federated learning to be more suitable for real-world practical application, particularly in scenarios where there is limited communication resources (e.g., lower network bandwidth).

The example embodiments of the methods and systems described herein may be adapted for use in different applications. For example, although the present disclosure describes example embodiments of the methods and systems in the context of federated learning, the example embodiments discussed herein may be adapted for use in distributed optimization of a model related to a task in general.

Examples of the methods and systems of the present disclosure may enable the use of federated learning in various practical applications. For example, applications of federated learning, as disclosed herein, may include learning a model for predictive text, image recognition or personal voice assistant on smartphones. Other applications of the present disclosure include application in the context of autonomous driving (e.g., autonomous vehicles may provide data to learn an up-to-date model related to traffic, construction, or pedestrian behavior, to promote safe driving). Other possible applications include applications in the context of network traffic management, where federated learning may be used to learn a model to manage or shape network traffic, without having to directly access or monitor a user's network data. Another application may be in the context of learning a model for medical diagnosis, without violating the privacy of a patient's medical data. Example embodiments of the present disclosure may also have applications in the context of the internet of things (IoT), in which a user device may be any IoT-capable device (e.g., lamp, fridge, oven, desk, door, window, air conditioner, etc. having IoT capabilities).

In an example 1, the present disclosure describes a method performed by a user device, the method including: computing a proximal map using a current state of a model and user data stored in the memory; transmitting the computed proximal map to a server; transmitting feedback to the server, the feedback representing a current state of the computing system; receiving, from the server, a model update; and updating values of weights of the model using the received model update.

In an example 2, the present disclosure describes a method performed by a user device, the method including: computing a weighted proximal map using a current state of a model and user data stored in the memory; transmitting the computed weighted proximal map to a server; transmitting feedback to the server, the feedback representing a current state of the computing system; receiving, from the server, updated optimization parameters and a consensus projection for a parameterized optimization algorithm; computing a model update using the received updated optimization parameters and the consensus projection in the parameterized optimization algorithm; and updating values of weights of the model using the computed model update.

In any of example 1 or example 2, the method may further include: computing a loss function representing performance of a current state of the model; wherein the loss function is included in the feedback transmitted to the server.

In any of example 1 or example 2, the method may further include: implementing a neural network having a memory, wherein the neural network is trained to output, from a current state of user data stored in the memory, a feature vector representing a historical trend of features relevant to the model.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute example embodiments of the methods disclosed herein. The machine-executable instructions may be in the form of code sequences, configuration information, or other data, which, when executed, cause a machine (e.g., a processor or other processing device) to perform steps in a method according to example embodiments of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method performed by a server, the method comprising:
receiving, from each of a plurality of user devices, a respective proximal map;
receiving, from each of the plurality of user devices, respective feedback representing a current state of each respective user device;
computing an update to optimization parameters of a parameterized optimization algorithm, using the received feedback;
computing model updates, each model update corresponding to a respective model at a respective user device, using the received proximal maps and the parameterized optimization algorithm having the updated optimization parameters; and
transmitting each model update to each respective client for updating the respective model.

2. The method of claim 1, wherein the update to the optimization parameters is computed for one round of training in a defined training period, and the optimization parameters are fixed for other rounds of training in the defined training period.

3. The method of claim 1, wherein the update to the optimization parameters is computed using a K-armed bandit algorithm.

4. The method of claim 1, wherein computing the update to the optimization parameters comprises computing the update to the optimization parameters using a reinforcement learning agent, wherein the reinforcement learning agent learns a policy to map the received feedback to the updated optimization parameters.

5. The method of claim 4, wherein the feedback received from each user device includes a loss function computed using the current state of the respective model at each user device, and wherein the reinforcement learning agent learns the policy using a cumulative reward computed from the loss functions received from the user devices.

6. The method of claim 1, wherein the update to the optimization parameters is computed using a pre-trained policy, wherein the policy is pre-trained using a supervised learning algorithm to map loss functions received as feedback from the user devices to the updated optimization parameters.

7. The method of claim 1, wherein computing the model updates comprises:
computing a set of weighted proximal map auxiliary variables using the received proximal maps, a set of prior model updates, and a first one of the updated optimization parameters;
computing a set of second auxiliary variables using the set of weighted proximal map auxiliary variables, a projection of the set of weighted proximal map auxiliary variables onto a consensus set, and a second one of the updated optimization parameters; and
computing the model updates using the set of prior model updates, the set of second auxiliary variables, and a third one of the update optimization parameters.

8. The method of claim 1, wherein the feedback representing a current state of each respective user device represents at least one of: a current state of user data local to the respective user device, a current state of an observed environment, or a current state of the model of the respective user device.

9. A method performed by a server, the method comprising:
receiving, from each of a plurality of user devices, a respective weighted proximal map;
receiving, from each of the plurality of user devices, respective feedback representing a current state of each respective user device;
computing an update to optimization parameters of a parameterized optimization algorithm, using the received feedback;
computing, using the weighted proximal maps, a consensus projection; and
transmitting the updated optimization parameters and computed consensus projection to each of the plurality of user devices, to enable updating a respective model at each respective user device.

10. The method of claim 9, wherein the update to the optimization parameters is computed using a K-armed bandit algorithm.

11. The method of claim 9, wherein computing the update to the optimization parameters comprises computing the update to the optimization parameters using a reinforcement learning agent, wherein the reinforcement learning agent learns a policy to map the received feedback to the updated optimization parameters.

12. The method of claim 11, wherein the feedback received from each user device includes a loss function computed using the current state of the respective model at each user device, and wherein the reinforcement learning agent learns the policy using a cumulative reward computed from the loss functions received from the user devices.

13. The method of claim 9, wherein the update to the optimization parameters is computed using a pre-trained policy, wherein the policy is pre-trained using a supervised learning algorithm to map loss functions received as feedback from the user devices to the updated optimization parameters.

14. A computing system comprising:
a memory; and
a processing unit in communication with the memory, the processing unit configured to execute instructions to cause the computing system to:
receive, from each of a plurality of user devices, a respective proximal map;
receive, from each of the plurality of user devices, respective feedback representing a current state of each respective user device;
compute an update to optimization parameters of a parameterized optimization algorithm, using the received feedback;
compute model updates, each model update corresponding to a respective model at a respective user device, using the received proximal maps and the parameterized optimization algorithm having the updated optimization parameters; and
transmit each model update to each respective client for updating the respective model.

15. The system of claim 14, wherein the update to the optimization parameters is computed for one round of training in a defined training period, and the optimization parameters are fixed for other rounds of training in the defined training period.

16. The system of claim 14, wherein the update to the optimization parameters is computed using a K-armed bandit algorithm.

17. The system of claim 14, wherein the processing unit is further configured to execute instructions to cause the computing system to compute the update to the optimization parameters by computing the update to the optimization parameters using a reinforcement learning agent, wherein the reinforcement learning agent learns a policy to map the received feedback to the updated optimization parameters.

18. The system of claim 17, wherein the feedback received from each user device includes a loss function computed using the current state of the respective model at each user device, and wherein the reinforcement learning agent learns the policy using a cumulative reward computed from the loss functions received from the user devices.

19. The system of claim 14, wherein the update to the optimization parameters is computed using a pre-trained policy, wherein the policy is pre-trained using a supervised learning algorithm to map loss functions received as feedback from the user devices to the updated optimization parameters.

20. The system of claim 14, wherein the feedback representing a current state of each respective user device represents at least one of: a current state of user data local to the respective user device, a current state of an observed environment, or a current state of the model of the respective user device.
